(19) United States
(12) Patent Application Publication
(10) Pub. No.: US 2021/0049723 A1
(43) Pub. Date: Feb. 18, 2021

(54) SYSTEM AND METHOD FOR PROACTIVE MARKETING OF A VEHICLE SHARING SERVICE

(71) Applicant: Toyota Motor North America, Inc., Plano, TX (US)

(72) Inventors: Aghyad Saleh, Grand Prairie, TX (US); Scott R. Meyer, Allen, TX (US)

(21) Appl. No.: 16/537,900

(22) Filed: Aug. 12, 2019

(51) Int. Cl. G06Q 50/30; G06Q 30/02; G06T 11/00; H04W 4/02; H04W 4/40; G08B 7/06

(52) U.S. Cl. CPC G06Q 50/30; G06Q 30/0261; G06Q 30/0267; G08B 7/06; G06T 11/00; H04W 4/023; H04W 4/40; G06Q 30/0264

(57) ABSTRACT

A vehicle sharing service system for proactive marketing of a vehicle sharing service includes one or more processors, a network access device, and a memory device, wherein the network access device and the memory device are in communication with the one or more processors. The memory device stores a customer location module and a communications module. The customer location module causes the one or more processors to determine when at least one mobile device of at least one potential customer is located within a predetermined distance to one or more vehicles of the vehicle sharing service. The communications module causes the one or more processors to transmit offer information for using the one or more vehicles to the at least one mobile device of the at least one potential customer when located within the predetermined distance to the one or more vehicles.

### TECHNICAL FIELD

The subject matter described herein relates, in general, to a system and method for marketing a vehicle sharing service to potential customers.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Vehicle sharing services, sometimes referred to as car-sharing services, is a model of vehicle rental where persons rent vehicles for short periods, sometimes by the hour. In some examples, the vehicles that are utilized for vehicle sharing may be owned by organizations, such as vehicle rental companies, but may also be owned by private individuals.

Some vehicle sharing service providers advertise their vehicle sharing service using traditional methods, such as billboards, television advertisements, social media, Internet-based advertisements, and the like. These advertisements may direct individuals wishing to engage the vehicle sharing service to a website, where the person can reserve the vehicle they would like to rent or offer their vehicle for rental.

### SUMMARY

This section generally summarizes the disclosure and is not a comprehensive explanation of its full scope or all its features.

In one embodiment, a method for proactive marketing of a vehicle sharing service includes the steps of determining, by a vehicle sharing service system, when at least one mobile device of at least one potential customer is located within a predetermined distance to one or more vehicles of the vehicle sharing service and transmitting offer information for using the one or more vehicles from the vehicle sharing service system to the at least one mobile device of the at least one potential customer when the at least one mobile device of the at least one potential customer is located within the predetermined distance to the one or more vehicles.

In another embodiment, a vehicle sharing service system includes one or more processors, a network access device, and a memory device, wherein the network access device and the memory device are in communication with the one or more processors. The memory device stores a customer location module and a communications module. The customer location module causes the one or more processors to determine when at least one mobile device of at least one potential customer is located within a predetermined distance to one or more vehicles of the vehicle sharing service. The communications module causes the one or more processors to transmit offer information for using the one or more vehicles to the at least one mobile device of the at least one potential customer when located within the predetermined distance to the one or more vehicles.

In another embodiment, a non-transitory computer-readable medium for proactive marketing of a vehicle sharing service includes instructions that when executed by one or more processors cause the one or more processors to determine, by a vehicle sharing service system, when at least one mobile device of at least one potential customer is located within a predetermined distance to one or more vehicles of the vehicle sharing service and transmit offer information for using the one or more vehicles from the vehicle sharing service system to the at least one mobile device of the at least one potential customer when the at least one mobile device of the at least one potential customer is located within the predetermined distance to the one or more vehicles.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an example of a method for proactive marketing of a vehicle sharing service;

FIG. 2 illustrates a detailed view of a vehicle sharing service system that utilizes proactive marketing of a vehicle sharing service;

FIGS. 3A-3C illustrate augmented reality visualizations displayed on a display device of a mobile device of a potential customer of a vehicle sharing service; and

FIG. 4 illustrates a method for proactive marketing of a vehicle sharing service.

### DETAILED DESCRIPTION

A system and method for proactively marketing a vehicle sharing service may include a vehicle sharing service system. The vehicle sharing service system can determine when a mobile device of a potential customer is within a specified distance from a vehicle that is part of a vehicle sharing service. Once it has been determined that the mobile device is within a specified distance from the vehicle that is part of the vehicle sharing service, an offer from the vehicle service system is transmitted to the mobile device of the potential customer. This offer may include information regarding the vehicle such as the make, model, features, and price for renting the vehicle. After receiving this offer from the vehicle sharing service system, the potential customer can choose to accept, decline, or ignore the offer via the mobile device. The acceptance of this offer is transmitted to the vehicle sharing service and the potential customer can then operate the vehicle that they have rented from the vehicle sharing service.

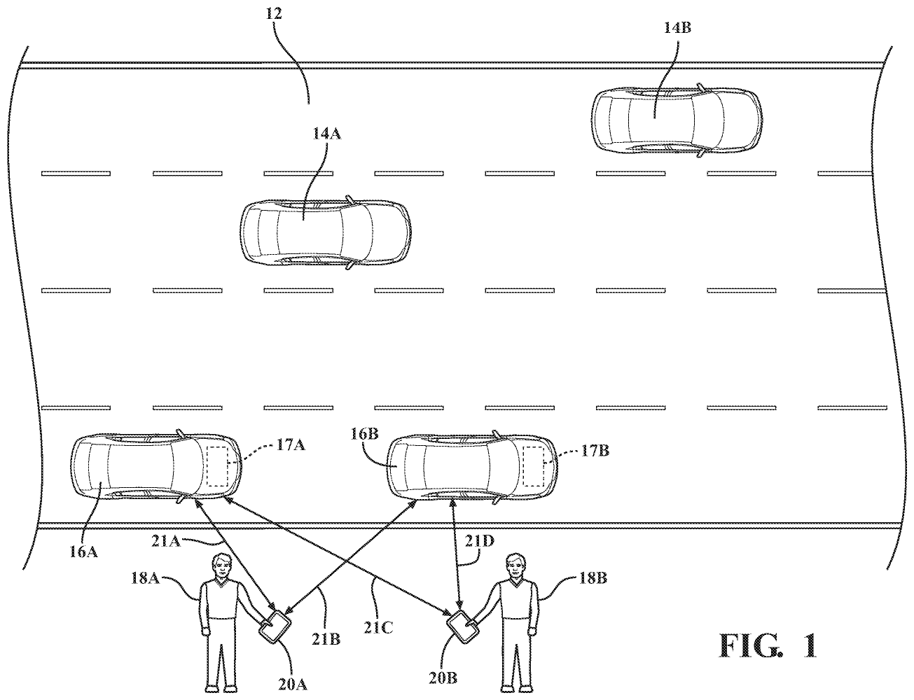

Referring to FIG. 1, an example 10 illustrating a system and methodology for proactively marketing a vehicle sharing service is shown. In this example 10, illustrated is a roadway 12 that may be located outside and exit of an arrival terminal at an airport. Again, it should be understood that the example 10 is only an example and is merely meant to illustrate the proactive marketing of a vehicle sharing service shown and described in this disclosure. As such, the example 10 could be at any one of several different locations wherein shared vehicles may be present, such as parking lots, bus stations, rapid transit stations, or any conceivable place where a shared vehicle may be located.

Here, the roadway 12 has several different vehicles 14A and 14B in the form of automobiles that are traveling thereon. In addition to the vehicles 14A and 14B that are traveling on the roadway 12, shared vehicles 16A and 16B are parked near a side 19 of the roadway 12. Again, this is merely an example, and it should be understood that the shared vehicles 16A and/or 16B may be parked or located at any suitable place. Furthermore, it should be understood that any one of several different shared vehicles may apply to this example.

The shared vehicles 16A and 16B may be any one of several different types of vehicles capable of transporting persons or items from one location to another. In the example shown in FIG. 1, the shared vehicles 16A and 16B are in the form of an automobile. However, the shared vehicles 16A and 16B may take any one of several different forms, such as a truck, heavy-duty truck, tractor-trailer, tractor, mining vehicle, military vehicle, and the like. The shared vehicles 16A and/or 16B may also include other types of vehicles, such as scooters, bicycles, motorcycles, skateboards, all-terrain vehicles, hoverboards, and other mobility devices. In addition, the shared vehicles 16A and 16B may not be limited to ground-based vehicles but could also include aircraft and seagoing vessels as well.

The shared vehicles 16A and/or 16B may also include one or more electronic systems 17A and/or 17B, respectively. The electronic systems 17A and/or 17B may be able to perform any one of several different methodologies disclosed in this disclosure. The electronic system 17A and 17B will be described in greater detail later in this disclosure.

The example 10 also illustrates potential customers 18A and 18B. The potential customers 18A and/or 18B may be potential customers of a vehicle sharing service. As such, the potential customers 18A and/or 18B may be interested in renting the vehicles 16A and/or 16B from a vehicle sharing service provider. The potential customers 18A and 18B may also have mobile devices 20A and/or 20B, respectively. The mobile devices 20A and/or 20B may be any one of several different mobile devices. As such, the mobile devices 20A and/or 20B may be in the form of a mobile phone, tablet, personal computer, notebook computer or any device capable of transmitting and/or receiving data via a network, such as the Internet.

In the example 10, the potential customers 18A and 18B both desire to rent a vehicle from a vehicle sharing service, such as vehicles 16A and/or 16B. Here, when it is determined that the mobile devices 20A and/or 20B are within a predetermined distance from the vehicle 16A and/or 16B, offer information regarding the potential rental of the vehicle 16A and/or 16B are provided to the mobile devices 20A and/or 20B. The offer information may be transmitted by the electronic systems 17A and/or 17B to the mobile devices 20A and/or 20B or may be transmitted to the mobile devices 20A and/or 20B from a remote server. The offer information could include information regarding the make, model, features, and price for renting the vehicle 16A and/or 16B. After receiving the offer information, the potential customers 18A and/or 18B may decide to rent the vehicle 16A and/or 16B.

In the example 10, the mobile device 20A of the potential customer 18A is a distance 21A from the vehicle 16A and a distance 21B from the vehicle 16B. In this example, the distance 21A between the mobile device 20A and the vehicle 16A is within a predetermined distance. As such, the mobile device 20A of the potential customer 18A will receive offer information for renting the vehicle 16A. Conversely, the distance 21B between the mobile device 20A of the potential customer 18A and the vehicle 16B is greater than the predetermined distance. As such, the mobile device 20A will not receive any offer information regarding rental of the vehicle 16B.

In like manner, the mobile device 20B of the potential customer 18B is a distance 21C away from the vehicle 16A. In addition, the mobile device 20B is a distance 21D away from the vehicle 16B. In this example, the distance 21C is greater than the predetermined distance and therefore the mobile device 20B of the potential customer 18B will not receive offer information for renting the vehicle 16A. However, the distance 21D between the vehicle 16B and the mobile device 20B is within the predetermined distance and therefore the mobile device 20B will receive offer information for renting the vehicle 16B.

The predetermined distance can vary based on different applications. For example, in situations where the number of vehicles of a vehicle sharing service outnumbers the number of potential customers based on the number of mobile devices, the predetermined distance may be made much shorter. Conversely, if the number of potential customers based on the number of mobile devices outnumbers the number of vehicles of a vehicle sharing service, the distance may be increased. By increasing or decreasing the predetermined distance, a match between the number of vehicles of a vehicle sharing service with the number of mobile devices of potential customers can be made to even out supply of the shared vehicles with the demand of these shared vehicles.

Other methodologies may also be employed for determining the predetermined distance. For example, the potential customer may inform the vehicle sharing service of their mobility limitations. If a potential customer has a limited ability to walk or otherwise travel, the predetermined distance may be set to a shorter distance not to exceed the ability of the potential customer to travel to the shared vehicle. In another example, the predetermined distance may be determined on historical crowdsourcing data indicating the average distance a person is willing to walk or travel to a shared vehicle and/or historical data regarding that specific potential customer and the distances they are willing to travel to a shared vehicle.

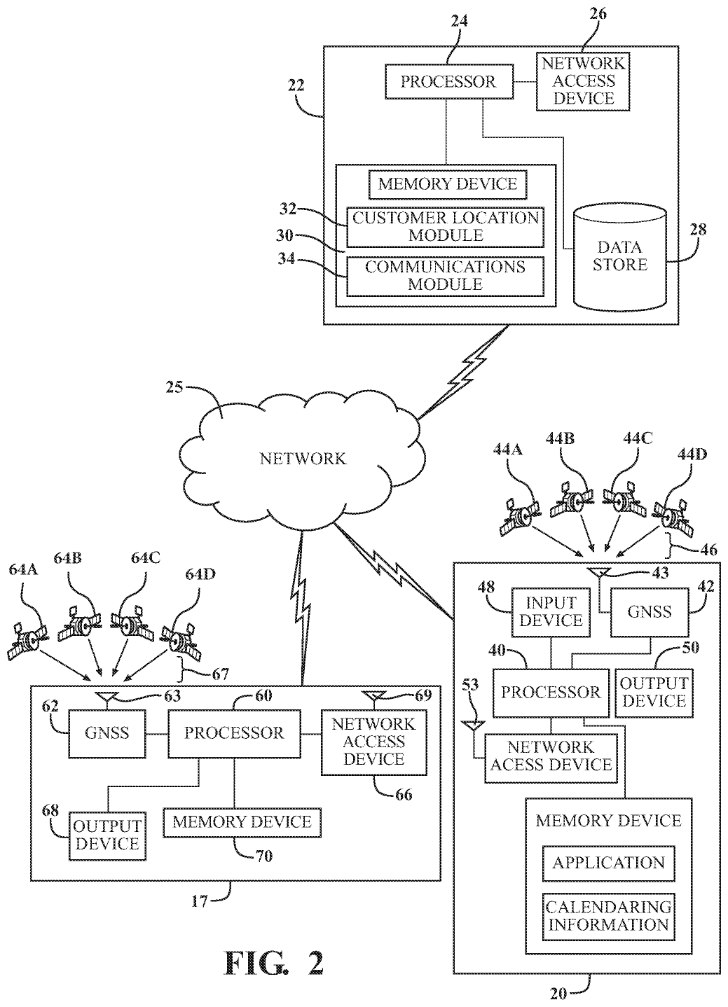

Referring to FIG. 2, illustrated are more detailed views of the electronic system 17, the mobile device 20, and a vehicle sharing system 22. The electronic system 17 may be similar to the electronic system 17A and/or 17B of FIG. 1. The mobile device 20 may be similar to the mobile devices 20A and/or 20B of FIG. 1.

With regards to the vehicle sharing system 22, the vehicle sharing system 22 may include one or more processors 24, a network access device 26, a data store 28 and/or a memory device 30. The network access device 26, data store 28 and/or the memory device 30 may each be in communication with the one or more processors 24.

As to the network access device 26, the network access device 26 allows the one or more processors 24 of the vehicle sharing system 22 to communicate with a network 25, such as the Internet. As such, the network access device 26 may be any one of several different components that allow the transmission of information to the network 25 and therefore to other electronic systems and subsystems connected to the network 25. These electronic systems and subsystems could include the electronic system 17 of a vehicle and/or the mobile device 20.

The data store 28 may store one or more types of data. The data store 28 can include volatile and/or non-volatile memory. Examples of suitable data stores 28 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 28 can be a component of the one or more processors 24 or the data store 28 can be operatively connected to the one or more processors before for use thereby. The term “operatively connected” or “in communication with” as used throughout this description, can include direct or indirect connections, including connections without direct physical contact.

The memory device 30 may be any type of memory capable of storing information that can be utilized by the one or more processors 24. As such, the memory device 30 may be a solid-state memory device, magnetic memory device, optical memory device, and the like. In this example, the memory device 30 is separate from the one or more processors 24, but it should be understood that the memory device 30 may be incorporated within any of the one or more processors 24, as opposed to being a separate device. Further, the memory device 30 may be incorporated within the data store 28 or separate as shown.

The memory device 30 may be capable of storing one or more modules that include instructions that when executed by the one or more processors 24 cause the one or more processors 24 to perform any one of several different methods disclosed in this disclosure. In this example, the memory device 30 includes a customer location module 32 and a communication module 34.

The customer location module 32 includes instructions that when executed by the one or more processors 24 cause the one or more processors 24 to determine when at least one mobile device, such as the mobile device 20, of at least one potential customer is located within a predetermined distance to one or more vehicles, such as vehicles 16A and/or 16B of FIG. 1, of the vehicle sharing service.

The customer location module 32 may be able to determine the distance between the mobile device 20 and of a shared vehicle by receiving location information from the electronic system 17 of the shared vehicle and/or the mobile device 20. The customer location module 32 may configure the one or more processors 24 to determine the relative distance between the vehicle and the mobile device 20. Additionally or alternatively, the relative distance between the vehicle and the mobile device 20 may be based on calendaring information, which may indicate the position of the mobile device 20 in the future. Based on this information, the customer location module 32 may be able to determine a future position of both the vehicle and the mobile device 20 and determine when the mobile device 20 is within a predetermined distance from the shared vehicle.

The communication module 34 includes instructions that when executed by the one or more processors 24 cause the one or more processors 24 to transmit, via the network access device 26, offer information for using the one or more shared vehicles to the mobile device 20 of a potential customer when the mobile device 20 of the potential customer is located within the predetermined distance to the one or more shared vehicles. The communications module 34 may also include instructions that configure the one or more processors 24 to receive from the mobile device 20 of the potential customer a confirmation signal indicating that the potential customer has accepted (or declined) the offer for renting a shared vehicle.

The offer information may include an offer for renting the shared vehicle and information regarding renting the shared vehicle. The offer information could include the make and model of the vehicle, features of the vehicle, location of the vehicle, the price for renting the vehicle, or other relevant vehicle information.

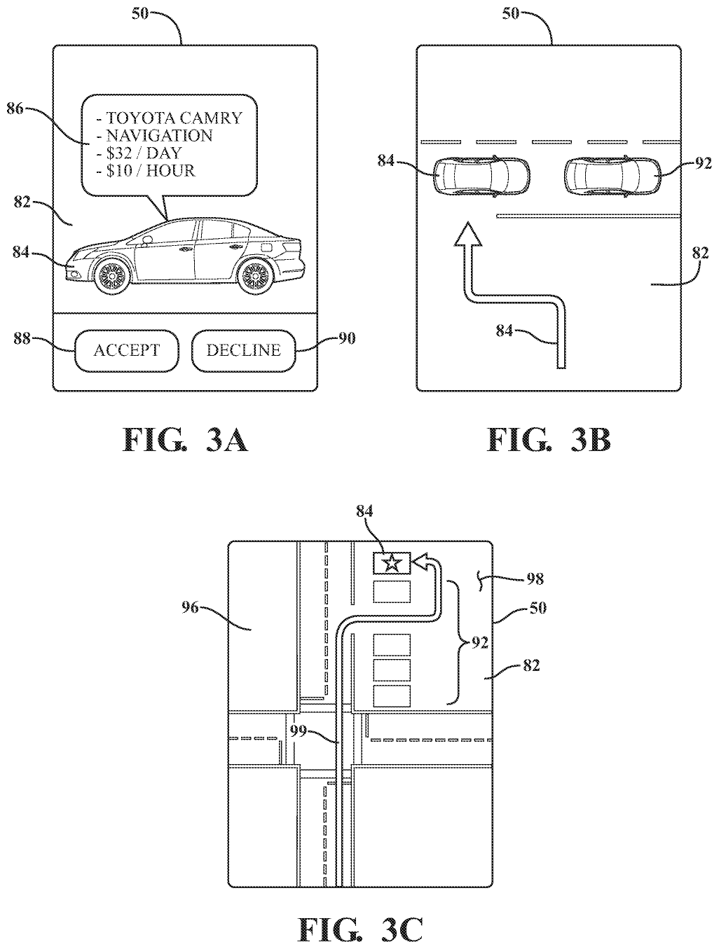

The communication module 34 may also configure the one or more processors 24 to transmit to the mobile device 20 the offer information in the form of an augmented reality visualization. The augmented reality visualization may be displayed on an output device 50 of the mobile device 20. In this example, the output device 50 may be a display monitor. Examples of the augmented reality visualization will be provided later in this disclosure and will be shown in FIGS. 3A-3C.

In another example, the communication module 34 may configure the one or more processors to send instructions to the electronic system 17 of a shared vehicle. The instruction sent to the electronic system 17 of the shared vehicle could include instructions that cause the electronic system 17 of the shared vehicle to activate an output device, such as output device 68, when it is determined that the mobile device 20 is located near the shared vehicle that has the electronic system 17. In this example, the output device 68 may be in the form of an audible or visual output device, such as a car horn or lights of the shared vehicle. When the mobile device 20 of the potential customer is near the shared vehicle having the electronic system 17, the electronic system 17 may cause the shared vehicle to either honk its horn and/or flash its lights so as to indicate which vehicle is the shared vehicle that the customer has rented. The distance between the mobile device 20 and the shared vehicle may be a distance wherein the customer can hear and or see the horns or lights of the vehicle, respectively. This distance may be approximately between zero and 100 meters.

The modules 32 and/or 34 could be a component of the one or more processors 24 or one or more of the modules 32 and/or 34 can be executed on and/or distributed among other processing systems to which the one or more processors 24 are operatively connected. For example, the electronic system 17 and/or the mobile device 20 could also execute and/or be included in the distribution among other processing systems to which the one or more processors 24 are operatively connected.

As to the mobile device 20, as previously stated, the mobile device 20 may be a mobile phone, tablet, personal computer, notebook computer, or a device capable of transmitting and/or receiving information wirelessly. The mobile device 20 may include one or more processors 40 in communication with a global navigation satellite system (“GNSS”) 42, an input device 48, an output device 50, a network access device 55, and/or a memory device 54.

The GNSS system 42 may be a satellite navigation system that provides autonomous geo-spatial positioning with global coverage. The GNSS system 42 may include any one of several different GNSS systems, such as GPS, GLONASS, Galileo, Beidou or other regional systems. The GNSS system 42 may be connected to an antenna 43 that can receive one or more signals 46 from one or more satellites 44A-44D. Based on the one or more signals 46 from the one or more satellites 44A-44D, the GNSS system 42 can determine the relative location of the mobile device 20. This relative location may be in the form of a coordinate system that may indicate the latitude, longitude, and/or altitude of the mobile device 20. As such, the GNSS system 42 allows for the one or more processors 24 of the vehicle sharing system 22 to determine the relative location of the mobile device 20 when the mobile device 20 transmits this information to the vehicle sharing system 22 via the network 25.

The input device 48 may be any type of device that allows the potential customer to provide information to the one or more processors 40 of the mobile device 20. As such, the input device 48 may be a touchscreen and/or keyboard that allows the potential customer to provide information to the one or more processors 40. The type of information that may be provided from the potential customer via the input device 48 may include information regarding if the potential customer has decided to accept or decline an offer for renting a shared vehicle provided by the vehicle sharing system 22. Other information provided from the potential customer could include calendaring information indicating the future location of the mobile device 20 and/or the potential customer at a future time. As stated before, the vehicle sharing system 22 may utilize this information to determine a future time wherein the mobile device 20 and/or the potential customer is within a predetermined distance from a shared vehicle. The vehicle sharing system 22 may then provide offer information to the mobile device 20 regarding potentially renting a shared vehicle at this future time, the present, or a time between the present and future time.

The output device 50 may be any type of device that allows the potential customer to receive information from the one or more processors 40 of the mobile device 20. The information from the one or more processors 40 could be information that originated from the vehicle sharing system 22. Additionally, the input device 48 and the output device 50 may be incorporated as a touchscreen that allows for inputting information from the potential customer as well as displaying information to the potential customer. The information displayed by the output device 50 could include offer information from the vehicle sharing system 22. This offer information could be in the form of an augmented reality visualization, which will be described later in this disclosure.

The network access device 55 allows the one or more processors 40 of the mobile device 20 to communicate with a network 25, such as the Internet. As such, the network access device 55 may be any one of several different components that allow the transmission of information to the network 25 and therefore to other electronic systems and subsystems connected to the network 25. These electronic systems and subsystems could include the vehicle sharing system 22 and/or the electronic system 17 of a shared vehicle. The network access device 55 may be connected to an antenna 53 that allows for the wireless transmission and reception of data to and from the network 25 and any connected systems and subsystems.

The memory device 54 may include instructions for executing any one of several different methodologies described in this disclosure. As such, the mobile device 20 may perform some or all the functions of the vehicle sharing system 22 and/or electronic system 17 of the vehicle. In this example, the memory device 54 includes an application 56. The application 56 may be an application that allows for communicating with the vehicle sharing system 22 and/or the electronic system 17 of the vehicle.

The application 56 may be an application that allows the mobile device 20 to send and/or receive information from the electronic system 17 of a shared vehicle and/or the vehicle sharing system 22. The application 56 may allow the mobile device 20 to receive offer information from the vehicle sharing system 22 and then display the offer information on the output device 50. In addition, the application 56 may allow the mobile device 20 to send an accepted signal to the vehicle sharing system 22 that indicates the potential customer accepts the offer contained in the offer information or a signal rejecting the offer contained in the offer information.

The memory device 54 may also include calendaring information 58. As stated previously, the calendaring information 58 may be utilized by the vehicle sharing system 22 to determine when in the future that the mobile device 20 and or the potential customer will be located such that they are within a predetermined distance from a shared vehicle and therefore may be interested in renting the shared vehicle.

With regards to the electronic system 17 of the vehicle, the electronic system 17 may include one or more processors 60 that are in communication with a GNSS system 62, a network access device 66, an output device 68 and/or memory device 70. Similar to the network access device 55 of the mobile device 20, the network access device 66 may include any one of a number of circuits that allow the one or more processors 60 to communicate with the network 25 and therefore the vehicle sharing system 22 and/or the mobile device 20. The network access device 66 may be connected to an antenna 69, which allows for the wireless transmission of information with the network 25.

The GNSS system 62 includes an antenna 63 that is capable of receiving one or more signals 67 from one or more satellites 64A-64D. Based on the signals 67 received from the satellites 64A-64D. The GNSS system 62 can determine the location of any vehicle in which the electronic system 17 is installed. As such, the location of electronic system 17 and therefore the shared vehicle in which it is installed can be transmitted to the vehicle sharing system 22 via the network 25. The vehicle sharing system 22 may then be able to utilize the location of the vehicle and the location of the mobile device 20 to determine if the mobile devices within a predetermined distance from the shared vehicle which has the electronic system 17 installed within.

The output device 68 may be any type of output device that can inform a potential customer regarding the presence of a vehicle in which the electronic system 17 is installed within. As stated previously, the output device 68 may be a horn and/or lights of the shared vehicle. As the mobile device 20 comes within a visual or audible range of the shared vehicle in which the electronic system 17 is installed, the output device 68 may activate the horns and/or lights of the shared vehicle so as to indicate to the potential customer the location of the shared vehicle.

The memory device 70 may include information that can be utilized by the one or more processors 60. Like the memory device 54, the memory device 70 may be any memory device capable of storing information that may be utilized by the one or more processors 60. As such, the memory device may be a solid-state memory device, an optical memory device, a magnetic memory device, and the like. Furthermore, the memory device 70 may be incorporated within the one or more processors 60 or maybe separate from the one or more processors 60 as shown.

The memory device 70 may include any one of several different modules allowing the one or more processors to perform any one of the methodologies disclosed in this disclosure. As such, the memory device 70 may include the customer location module 32 and/or the communication module 34. In one example, the vehicle sharing system 22 may be incorporated within the electronic system 17 of the shared vehicle. As such, in this example, the electronic system 17 of the shared vehicle would perform the operations previously mentioned as being performed by the vehicle sharing system 22.

Referring to FIGS. 3A-3C, different examples of information, including offer information displayed on the output device 50 of the mobile device 20 of FIG. 2 is shown. In FIG. 3A, the output device 50 displays and augmented reality visualization 82, wherein the augmented reality visualization 82 includes a shared vehicle 84. Augmented reality is a technology that superimposes a computer-generated image on the user's view of the real world, thus providing a composite view. In this example, the user is the potential customer. Here, the shared vehicle 84 is present in the real world but offer information 86 is superimposed. Offer information 86 is displayed as a bubble above the shared vehicle 84. Here, the offer information 86 includes information regarding the make and model of the shared vehicle 84, special features of the shared vehicle 84, such as navigation, and the cost of renting the shared vehicle 84, which could include the cost per day or the cost per hour of renting the shared vehicle 84.

The augmented reality visualization 82 may also include buttons 88 and 90. If the potential customer selects button 88, the potential customer is accepting the offer contained within the offer information. Conversely, if the potential customer selects button 90, the potential customer is declining the offer contained within the offer information.

FIG. 3B illustrates another augmented reality visualization 82. Here, shared vehicles 84 and 92 are shown in the augmented reality visualization 82. In addition to the vehicles 84 and 92, a navigation element 94, in the form of an arrow, provides directions to the potential customer to the shared vehicle 84 which they have rented.

FIG. 3C illustrates directions to the shared vehicle 84 in the form of a map 96 displayed on the output device 50. Here, the map 96 includes a parking lot 98. The parking lot 98 includes vehicles 92, as well as the shared vehicle 84 that the potential customer wishes to rent. The augmented reality visualization 82 of this figure also includes a navigation element 99 that directs the potential customer to the shared vehicle 84.

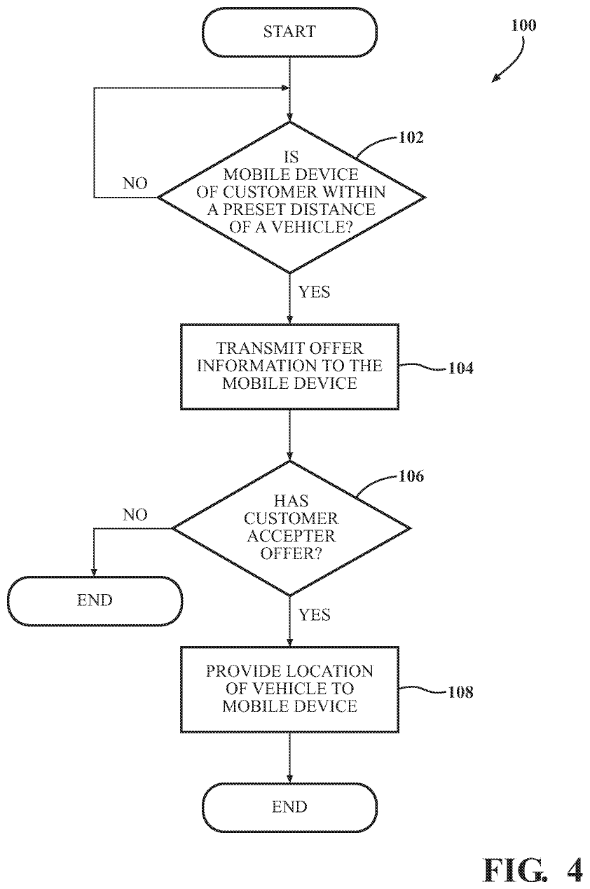

Referring to FIG. 4, a method 100 for proactive marketing of a vehicle sharing service is shown. The method 100 will be explained from the perspective of the vehicle sharing system 22. However, it should be appreciated that the method 100 is not limited to being implemented within the vehicle sharing system 22 but is instead one example of a system that may implement the method 100.

The method 100 begins at step 102. At step 102, the customer location module 32 of the vehicle sharing system 22 configures the one or more processors 24 to determine if the mobile device 20 is within a predetermined distance of the shared vehicle. This may be performed by having the one or more processors 24 receive location information from the electronic system 17 of the vehicle and the mobile device 20. Location information from the electronic system 17 of the shared vehicle may be generated by the GNSS system 62 of the electronic system 17. In like manner, the location information of the mobile device 20 may be generated by the GNSS system 42 of the mobile device 20. The customer location module 32 may then be able to determine if the mobile device 20 is within a predetermined distance from the shared vehicle.

As stated before, the predetermined distance can vary based on different applications. For example, in situations where the number of vehicles of a vehicle sharing service outnumbers the number of potential customers based on the number of mobile devices, the predetermined distance may be made much shorter. Conversely, if the number of potential customers based on the number of mobile devices outnumbers the number of vehicles of a vehicle sharing service, the distance may be increased. By increasing or decreasing the predetermined distance, a match between the number of vehicles of a vehicle sharing service with the number of mobile devices of potential customers can be made to even out supply of the shared vehicles with the demand of these shared vehicles.

Other methodologies may also be employed for determining the predetermined distance. For example, the potential customer may inform the vehicle sharing service of their mobility limitations. If a potential customer has a limited ability to walk or otherwise travel, the predetermined distance may be set to a shorter distance not to exceed the ability of the potential customer to travel to the shared vehicle. In another example, the predetermined distance may be determined on historical crowdsourcing data indicating the average distance a person is willing to walk or travel to a shared vehicle and/or historical data regarding that specific potential customer and the distances they are willing to travel to a shared vehicle.

If it is determined that the mobile device 20 is not within the predetermined distance of the shared vehicle, the method 100 will begin again or, alternatively, end. If the mobile device is within the predetermined distance from the shared vehicle, the method proceeds to step 104, wherein the communication module 34 configures the one or more processors 24 to transmit offer information to the mobile device 20. As stated before, the offer information could include information regarding the make, model, features, and/or price for renting the vehicle. The offer information may be transmitted to the mobile device 20 via the network 25.

In step 106, the communication module 34 configures the processor 24 to determine if the customer has accepted the offer. Here, the customer may accept the offer by utilizing the input device 48 of the mobile device 20. In one example, the potential customer may select the accept button 88 or the decline button 90 of the augmented reality visualization 82 as best shown in FIG. 3A. If the potential customer declines the offer by selecting button 90, the method ends.

However, if the customer has accepted the offer by selecting button 88, the method continues to step 108, wherein the communications module 34 configures the processor 24 to provide the location of the vehicle to the mobile device 20. The location of the vehicle may be in any one of several different forms. For example, FIG. 3B illustrates an augmented reality visualization wherein the shared vehicle 84 to be rented by the potential customer is pointed out by a navigation element 94. In the example shown in FIG. 3C, a map 96 is shown with a navigation element 99 directing the potential customer to the shared vehicle 84. In addition to providing these visualizations to the customer, the location of the vehicle may be provided to the customer by actuating the output device 68 of the electronic system 17 of the vehicle. Here, the output device 68 may be the horn and or lights of the vehicle. When the mobile device 20 of the customer gets within a closer distance of the vehicle, the horns and or lights of the vehicle may be actuated to indicate which vehicle is the vehicle that the potential customer has rented.

It should be appreciated that any of the systems described in this specification can be configured in various arrangements with separate integrated circuits and/or chips. The circuits are connected via connection paths to provide for communicating signals between the separate circuits. Of course, while separate integrated circuits are discussed, in various embodiments, the circuits may be integrated into a common integrated circuit board. Additionally, the integrated circuits may be combined into fewer integrated circuits or divided into more integrated circuits.

In another embodiment, the described methods and/or their equivalents may be implemented with computer-executable instructions. Thus, in one embodiment, a non-transitory computer-readable medium is configured with stored computer-executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer readable program code embodied, e.g., stored, thereon. Any combination of one or more computer-readable media may be utilized. The computer-readable medium may be a computer readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, other magnetic medium, an ASIC, a graphics processing unit (GPU), a CD, other optical medium, a RAM, a ROM, a memory chip or card, a memory stick, and other media from which a computer, a processor or other electronic device can read. In the context of this document, a computer-readable storage medium may be any tangible medium that can contain or store a program for use by or in connection with an instruction execution system, apparatus, or device.

The following includes definitions of selected terms employed herein. The definitions include various examples and/or forms of components that fall within the scope of a term, and that may be used for various implementations. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, may include one or more CMOS gates, combinations of gates, or other circuit components. Where multiple modules are described, one or more embodiments may include incorporating the multiple modules into one physical module component. Similarly, where a single module is described, one or more embodiments distribute the single module between multiple physical components.

Additionally, module, as used herein, includes routines, programs, objects, components, data structures, and so on that perform tasks or implement data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), as a graphics processing unit (GPU), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method for proactive marketing of a vehicle sharing service, the method comprising the steps of:
determining, by a vehicle sharing service system, when at least one mobile device of at least one potential customer is located within a predetermined distance to one or more vehicles of the vehicle sharing service; and
transmitting offer information for using the one or more vehicles from the vehicle sharing service system to the at least one mobile device of the at least one potential customer when the at least one mobile device of the at least one potential customer is located within the predetermined distance to the one or more vehicles.

2. The method of claim 1, further comprising the step of receiving from the mobile device of at least one potential customer a confirmation signal acceptance information in response to the offer information.

3. The method of claim 1, wherein the offer information includes at least one of: a make of the one or more vehicles, a model of the one or more vehicles, one or more features of the one or more vehicles, and a price for using the one or more vehicles.

4. The method of claim 1, further comprising the steps of:
receiving calendaring information regarding when the at least one mobile device of the at least one potential customer will be within the predetermined distance to the one or more vehicles; and
transmitting offer information for using the one or more vehicles from the vehicle sharing service system to the at least one mobile device of the at least one potential customer when the calendaring information indicates that the at least one mobile device of at least one potential customer will be within the predetermined distance at a future date.

5. The method of claim 1, wherein the offer information is displayed as an augmented reality visualization via a display device of the at least one mobile device of the at least one potential customer.

6. The method of claim 5, wherein the augmented reality visualization includes at least one of: a make of a vehicle, a model of the vehicle, one or more features of the vehicle, a price for using the vehicle, and directions to the one or more vehicles.

7. The method of claim 1, further comprising the step of providing an identifying alert from the one or more vehicles when the at least one potential customer is located within the predetermined distance to the one or more vehicles.

8. The method of claim 7, wherein the identifying alert from the one or more vehicles is at least one of an audible alert and visual alert.

9. The method of claim 1, wherein the vehicle sharing service system is located within the one or more vehicles.

10. A vehicle sharing service system for proactive marketing of a vehicle sharing service, the vehicle sharing service system comprising:
one or more processors;
a network access device in communication with the one or more processors; and
a memory device in communication with the one or more processors and storing:
a customer location module including instructions that when executed by the one or more processors cause the one or more processors to determine when at least one mobile device of at least one potential customer is located within a predetermined distance to one or more vehicles of the vehicle sharing service, and
a communications module including instructions that when executed by the one or more processors cause the one or more processors to transmit, via the network access device, offer information for using the one or more vehicles from the vehicle sharing service system to the at least one mobile device of the at least one potential customer when the at least one mobile device of the at least one potential customer is located within the predetermined distance to the one or more vehicles.

11. The vehicle sharing service system of claim 10, wherein the communications module further includes instructions that when executed by the one or more processors cause the one or more processors to receive from the mobile device of at least one potential customer a confirmation signal acceptance information in response to the offer information.

12. The vehicle sharing service system of claim 10, wherein the offer information includes at least one of: a make of the one or more vehicles, a model of the one or more vehicles, one or more features of the one or more vehicles, and a price for using the one or more vehicles.

13. The vehicle sharing service system of claim 10, wherein:
the communications module further includes instructions that when executed by the one or more processors cause the one or more processors to receive, via the network access device, calendaring information regarding when the at least one mobile device of the at least one potential customer;
the customer location module further includes instructions that when executed by the one or more processors cause the one or more processors to determine when the at least one mobile device of the at least one potential customer will be within the predetermined distance to the one or more vehicles based on the calendaring information; and
the communications module further includes instructions that when executed by the one or more processors cause the one or more processors to transmit, via the network access device, offer information for using the one or more vehicles from the vehicle sharing service system to the at least one mobile device of the at least one potential customer when the calendaring information indicates that the at least one mobile device of at least one potential customer will be within the predetermined distance at a future date.

14. The vehicle sharing service system of claim 10, wherein the offer information is displayed as an augmented reality visualization via a display device of the at least one mobile device of the at least one potential customer.

15. The vehicle sharing service system of claim 14, wherein the augmented reality visualization includes at least one of: a make of a vehicle, a model of the vehicle, one or more features of the vehicle, a price for using the vehicle, and directions to the one or more vehicles.

16. The vehicle sharing service system of claim 10, wherein the communications module further includes instructions that when executed by the one or more processors cause the one or more processors to transmit, via the network access device, an instruction to the one or more vehicles causing the one of more vehicles to provide an identifying alert when the at least one potential customer is located within the predetermined distance to the one or more vehicles.

17. The vehicle sharing service system of claim 16, wherein the identifying alert from the one or more vehicles is at least one of an audible alert and visual alert.

18. The vehicle sharing service system of claim 10, wherein the vehicle sharing service system is located within the one or more vehicles.

19. A non-transitory computer-readable medium for proactive marketing of a vehicle sharing service and including instructions that when executed by one or more processors cause the one or more processors to:
determine, by a vehicle sharing service system, when at least one mobile device of at least one potential customer is located within a predetermined distance to one or more vehicles of the vehicle sharing service; and
transmit offer information for using the one or more vehicles from the vehicle sharing service system to the at least one mobile device of the at least one potential customer when the at least one mobile device of the at least one potential customer is located within the predetermined distance to the one or more vehicles.

20. The non-transitory computer-readable medium of claim 19, further including instructions that when executed by one or more processors cause the one or more processors to receive from the mobile device of at least one potential customer a confirmation signal acceptance information in response to the offer information.
